(19) United States
(12) Patent Application Publication
(10) Pub. No.: US 2007/0274770 A1
(43) Pub. Date: Nov. 29, 2007

(54) Ball Joint

(75) Inventors: Yoshiyuki Sagisaka, Shizuoka (JP); Takahiro Oda, Shizuoka (JP); Shouji Nakagami, Shizuoka (JP); Keiichiro Suzuki, Shizuoka (JP)

Correspondence Address: DARBY & DARBY P.C., P.O. BOX 770, Church Street Station, New York, NY, 10008-0770, US

(73) Assignee: Kabushiki Kaisha Somic Ishikawa, Tokyo (JP)

(21) Appl. No.: 11/722,977

(22) PCT Filed: Dec. 19, 2005
(86) PCT No.: PCT/JP05/23267

§ 371 Date: Jun. 27, 2007

(30) Foreign Application Priority Data
Dec. 27, 2004 (JP) 2004-375398

(51) Int. Cl. F16C 11/00

(52) U.S. Cl. 403/132; 403/76

(57) ABSTRACT

A ball joint for preventing a ball seat from being rotated by a ball includes a ball seat in an inner chamber of a socket. A fitting portion of the ball seat with a plurality of holding surfaces is provided in proximity to a lower hemisphere of the ball. A fitting receiving portion of the ball seat has a plurality of contact surfaces which are in contact with holding surfaces. The ball seat is forcibly prevented from rotating a circumferential direction in the inner chamber by the contact of the holding surfaces with the contact surfaces to suppress the effect of a rotating torque of the ball joint on the ball seat.

### TECHNICAL FIELD

The present invention relates to a ball joint provided with a socket having an inner chamber in which a bearing seat holding a ball portion of a ball stud is housed.

### BACKGROUND ART

Conventionally, for example, ball joints used in automobile suspension devices or steering devices and the like have been known. And, such a ball joint generally includes a socket in an approximately cylindrical shape with a bottom having an inner chamber provided with an opening portion, a ball seat as being a flexible bearing seat fixed to the inner chamber of this socket and having an opening communicated with the opening portion, and a ball stud having a ball portion held so as to be slidable on a sliding surface in this ball seat and a stud portion inserted through the opening and the opening portion. And, the ball seat of such a ball joint is fixed to the inner chamber of the socket by a caulking deformation of a marginal portion of the opening portion of the socket.

And, in order to improve load bearing of the ball joint to improve durability, known is a construction to provide, at an outer circumferential surface of an end portion on the side opposite to the opening in the axial direction of the ball seat, a load receiving portion that comes into contact with a bottom surface portion of the inner chamber of the socket (see Patent Document 1, for example).

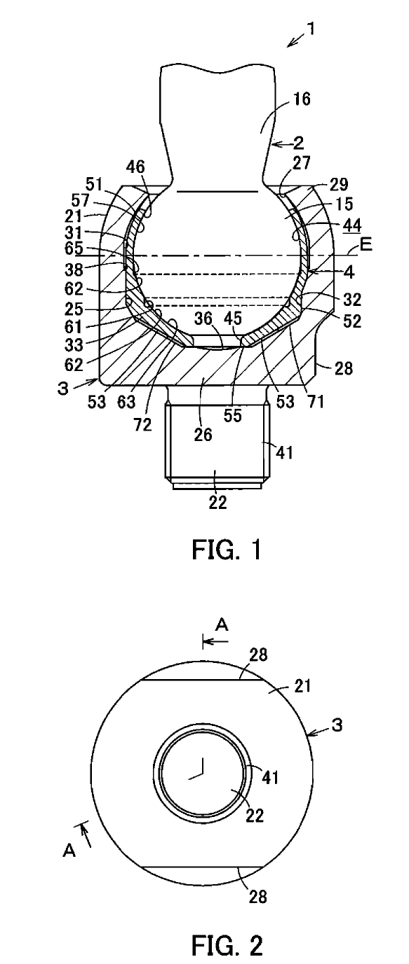

Patent Document 1: Japanese Laid-open Utility Model Publication No. 7-12621 (Pages 7-9, FIG. 1)

### DISCLOSURE OF THE INVENTION

### Problems to be Solved by the Invention

In the ball joint, when heat is generated on the ball seat by sliding between the ball portion of the ball stud and sliding surface and the like, the ball seat may be contracted by a heat history of this heat.

In this case, for the above-described ball joint, since the opening side of the ball seat is plastically deformed in the central axis direction by a caulking deformation of the marginal portion of the opening portion of the socket so as to only press the ball seat from the opening portion side to the bottom surface portion side of the inner chamber of the socket, there is no part to prevent the ball seat having a relatively smoothly structured outer circumferential surface from behaving in the circumferential direction. As a result, when the tightening margin is relieved by a contraction of the ball seat, the ball seat may be rotated following a swing or a rotation of the ball portion of the ball stud.

The present invention has been made in view of such problems, and an object thereof is to provide a ball joint capable of preventing the bearing seat from being rotated in a following manner.

### Means for Solving the Problems

A ball joint as set forth in the first aspect of the invention includes: a ball stud provided with a ball portion; an almost cylindrical bearing seat provided with a spherical sliding surface that holds the ball portion of the ball stud so as to be rotatable and an opening; and a socket in an approximately cylindrical shape with a bottom provided with an inner chamber in which the bearing seat holding the ball portion of the ball stud is housed, an opening portion communicated with the opening, and a bottom portion, wherein the socket is, apart from a position corresponding to an equator position of the ball portion held by the bearing seat to a side opposite to the opening portion in an axial direction and on the equator side of the bottom portion, provided with a fitting portion having a plurality of holding surfaces, and the bearing seat is provided with a fitting receiving portion having a plurality of contact surfaces that come into contact with the holding surfaces in a state housed in the inner chamber and being fitted with the fitting portion.

And, by providing, in the inner chamber of the socket housing the bearing seat that holds the ball portion of the ball stud so as to be slidable, at the position apart from a position corresponding to an equator position of the ball portion to the side opposite to the opening portion in the axial direction and on the equator side of the bottom portion, the fitting portion having a plurality of holding surfaces and by providing, in the bearing seat, the fitting receiving portion having a plurality of contact surfaces that come into contact with the holding surfaces in a state housed in the inner chamber and being fitted with the fitting portion, the bearing seat is forcibly prevented from rotating in the circumferential direction in the inner chamber by the contact of the holding surfaces with the contact surfaces while suppressing effects such as a rotating torque on characteristics of the ball joint, whereby the bearing seat is prevented from being rotated following a slide of the ball portion.

A ball joint as set forth in the second aspect of the invention is the ball joint as set forth in the first aspect of the invention, wherein the fitting portion and fitting receiving portion are formed in almost regular polygonal shapes, when viewed from the axial direction, by the holding surfaces and contact surfaces, respectively.

And, by forming the fitting portion and fitting receiving portion in almost regular polygonal shapes, when viewed from the axial direction, by the holding surfaces and contact surfaces, respectively, when fitting the bearing seat to the inner chamber of the socket, the bearing seat and socket are easily aligned in the circumferential direction.

A ball joint as set forth in the third aspect of the invention is the ball joint as set forth in the first aspect of the invention, wherein the fitting portion and fitting receiving portion are formed in almost regular octagonal shapes, when viewed from the axial direction, by the holding surfaces and contact surfaces, respectively.

And, by forming the fitting portion and fitting receiving portion in almost regular octagonal shapes, when viewed from the axial direction, by the holding surfaces and contact surfaces, respectively, when fitting the bearing seat to the inner chamber of the socket, the bearing seat and socket are easily aligned in the circumferential direction, and the fitting portion and fitting receiving portion are approximated to circular shapes, so that the ball joint characteristics are stabilized.

A ball joint as set forth in the fourth aspect of the invention is the ball joint according to any one of the first to third aspects of the invention, wherein the bearing seat is provided, at an outside surface on a side opposite to the opening of the fitting receiving portion in the axial direction, with projections that are press contacted with the inner chamber in a state fitted to the socket.

And, by providing, at an outside surface on a side opposite to the opening of the fitting receiving portion in the axial direction of the bearing seat, the projections that are press contacted with the inner chamber in a state fitted to the socket, the bearing seat can be more reliably prevented from being rotated in a following manner by the projections being deformed, and a load from the ball stud can be supported by the inner chamber of the socket, so that rigidity and durability can be improved.

### EFFECT OF THE INVENTION

According to the first aspect of the invention, by providing, in the inner chamber of the socket housing the bearing seat, at the position apart from a position corresponding to an equator position of the ball portion to the side opposite to the opening portion in the axial direction and on the equator side of the bottom portion, the fitting portion having a plurality of holding surfaces and by providing, in the bearing seat, the fitting receiving portion having a plurality of contact surfaces that come into contact with the holding surfaces in a state housed in the inner chamber and being fitted with the fitting portion, the bearing seat is forcibly prevented from rotating in the circumferential direction in the inner chamber by the contact of the holding surfaces with the contact surfaces while suppressing effects such as a rotating torque on characteristics of the ball joint, whereby the bearing seat can be prevented from being rotated following a slide of the ball portion.

According to the ball joint as set forth in the second aspect of the invention, in addition to the effect of the ball joint as set forth in the first aspect of the invention, by forming the fitting portion and fitting receiving portion in almost regular polygonal shapes, when viewed from the axial direction, by the holding surfaces and contact surfaces, respectively, when fitting the bearing seat to the inner chamber of the socket, the bearing seat and socket can be easily aligned in the circumferential direction.

According to the ball joint as set forth in the third aspect of the invention, in addition to the effect of the ball joint as set forth in the first aspect of the invention, by forming the fitting portion and fitting receiving portion in almost regular octagonal shapes, when viewed from the axial direction, by the holding surfaces and contact surfaces, respectively, when fitting the bearing seat to the inner chamber of the socket, the bearing seat and socket can be easily aligned in the circumferential direction, and the fitting portion and fitting receiving portion are approximated to circular shapes, so that the ball joint characteristics can be stabilized.

According to the ball joint as set forth in the fourth aspect of the invention, in addition to the effect of the ball joint as set forth in any one of the first to third aspects of the invention, by providing, at an outside surface on a side opposite to the opening of the fitting receiving portion in the axial direction of the bearing seat, the projections that are press contacted with the inner chamber in a state fitted to the socket, the bearing seat can be more reliably prevented from being rotated in a following manner by the projections being deformed, and a load from the ball stud can be supported by the inner chamber of the socket, so that rigidity and durability can be improved.

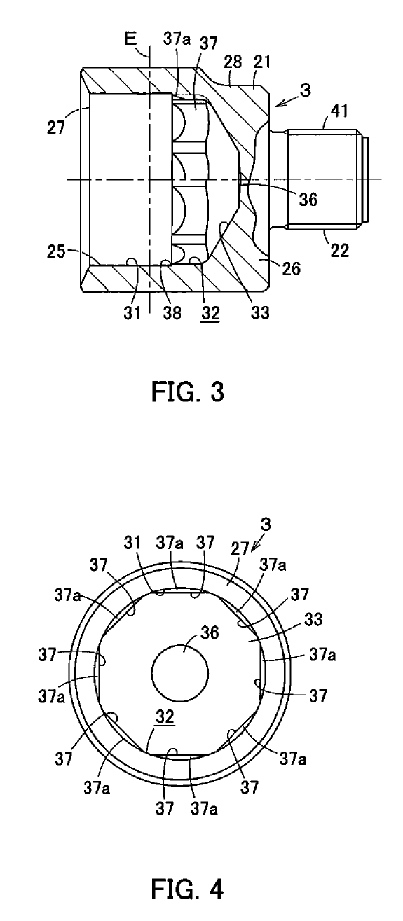

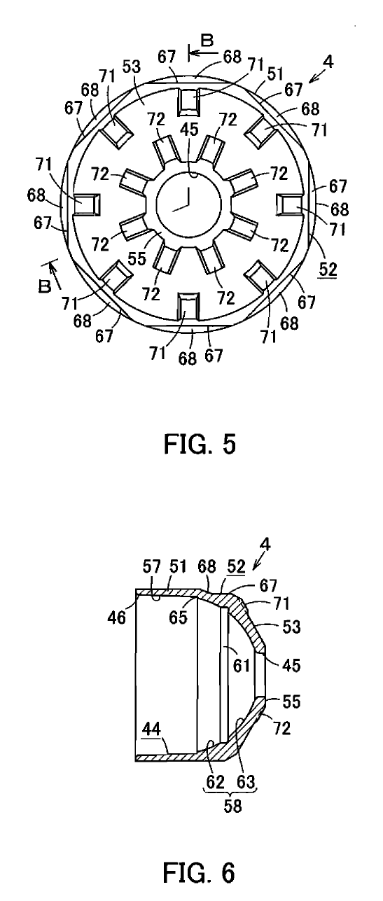

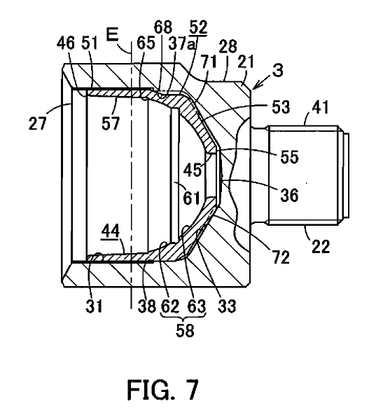

### BRIEF DESCRIPTION OF THE DRAWINGS

[FIG. 1] A sectional view showing a ball joint of an embodiment of the present invention.

[FIG. 2] A plan view showing the external side of a socket of the same ball joint as the above.

[FIG. 3] A sectional view of the same socket as the above along A-A in FIG. 2.

[FIG. 4] A plan view showing the internal side of the same socket as the above.

[FIG. 5] A plan view showing a bearing seat of the same ball joint as the above.

[FIG. 6] A sectional view of the same bearing seat as the above along B-B in FIG. 5.

[FIG. 7] A sectional view showing the same bearing seat as the above attached to the socket.

### DESCRIPTION OF SYMBOLS

1 Ball joint
2 Ball stud
3 Socket
4 all seat as bearing seat
15 Ball portion
25 Inner chamber
26 Bottom portion
27 Opening portion
32 Fitting portion
37 Holding surface
46 Opening
44 Sliding surface
52 Fitting receiving portion
67 Contact surface
71, 72 Projection
E Equator

### BEST MODE FOR CARRYING OUT THE INVENTION

Hereinafter, a construction of a bearing seat of an embodiment of the present invention will be described with reference to FIG. 1 through FIG. 7.

In FIG. 1, 1 denotes a ball joint, which includes a ball stud 2 made of steel or the like, a socket 3 in an approximately cylindrical shape with a bottom made of a metal or the like, a ball seat 4 made of a synthetic resin or the like as a bearing seat, and an unillustrated dust cover or the like formed of rubber, a soft synthetic resin, or the like in an approximately cylindrical shape. And, this ball joint 1 is used in, for example, a rack end or the like of an automobile steering device with its axial direction oriented sideways.

The ball stud 2 has a ball portion 15 held so as to be rotatable on the ball seat 4 and a stud portion 16 provided in a shaft form in a protruding manner from the ball portion 15.

The ball portion 15 is housed in the socket 3 in a state held on the ball seat 4.

Moreover, the stud portion 16 is protruded from the socket 3 and a tip portion thereof is connected to, for example, an unillustrated tie rod end.

Furthermore, the socket 3 has, as shown in FIG. 2 through FIG. 4, a socket body 21 in an approximately cylindrical shape with a bottom and a connecting portion 22 provided in a protruding manner from one axial end portion of the socket body 21 in the direction opposite to the stud portion 16 of the ball stud 2.

The socket body 21 is provided internally with an inner chamber 25 to which the ball seat 4 is fitted, is formed at one axial end portion thereof with a bottom portion 26 from which the connecting portion 22 is protruded, is formed with an opening portion 27 communicated with the inner chamber 25 at the other axial end portion thereof being on the side opposite to the bottom portion 26, and is provided with a pair of concave portions 28 at mutually opposing positions in an outer circumferential portion thereof. And, this socket body 21 holds the ball seat 4 in the inner chamber 25, and prevents the ball stud 2 from coming off from the socket 3 and ball seat 4, in a state where the ball seat 4 is fitted to the inner chamber 25, by forming a caulking portion 29 by deforming an outer marginal portion of the opening portion 27 by caulking in the central axis direction as shown in FIG. 1.

For the inner chamber 25, as shown in FIG. 3 and FIG. 4, from the opening portion 27 side to the bottom portion 26 side, an opening-portion-side inner circumferential surface portion 31, a fitting portion 32, an inclined surface portion 33, and a bottom surface portion 36 are continuously and concentrically formed in order, and the inclined surface portion 33 and bottom surface portion 36 being on the bottom portion 26 side are reduced in diameter in an inclined manner so as to be a surface on the opening portion 27 side of the bottom portion 26.

The opening-portion-side inner circumferential surface portion 31 is formed in a cylindrical inner surface shape having an inside diameter dimension slightly larger than the maximum outside diameter dimension of the ball seat 4. In addition, a fitting portion 32-side end portion of the opening-portion-side inner circumferential surface portion 31 is located on the bottom portion 26 side of a position corresponding to an equator E of the ball portion 15. In other words, a vicinity of the fitting portion 32-side end portion of the opening-portion-side inner circumferential surface portion 31 is at a position corresponding to the equator E of the ball portion 15.

Here, the equator E of the ball portion 15 means a position where the radius of the ball portion 15 is maximized on a plane orthogonal to the central axis of the ball stud 2.

In addition, the fitting portion 32 is formed in a cylindrical inner surface shape having an outside diameter dimension almost equal to the maximum outside diameter dimension of the ball seat 4, is provided with a plurality of, in the present embodiment, eight, holding surfaces 37 protruded to the central axis side of the socket 3, and is formed, in a continuous portion from the opening-portion-side inner circumferential surface portion 31, with a slight step portion 38 toward the central axis direction of the socket 3. Moreover, this fitting portion 32 is provided from a position apart from the position corresponding to the equator E of the ball portion 15 at a predetermined distance, in the present embodiment, for example, approximately 2 to 3 mm, to the bottom portion 26 side being the side opposite to the opening portion 27, to the inclined surface portion 33 being on the equator E side of the bottom portion 26.

The holding surfaces 37 are provided in plane shapes almost parallel to the axial direction of the socket 3, and on the opening portion 27 side, formed are inclined portions 37a inclined so as to be smoothly continuous to the opening-portion-side inner circumferential surface portion 31. Also, these holding surfaces 37 are apart at almost equal intervals in the circumferential direction of the socket 3. Therefore, the fitting portion 32 is formed in an almost regular polygonal shape, in the present embodiment, an almost regular octagonal shape, when viewed from the axial direction of the socket 3.

In addition, the step portion 38 becomes, as shown in FIG. 1, at the time of caulking deformation of the socket body 21, a cushioning portion located in a manner corresponding to the position of the equator E of the ball portion 15, and thereby relieves torque.

Furthermore, the inclined surface portion 33 is formed in a cylindrical inner surface shape inclined, from the fitting portion 32 to the bottom portion 26 side, toward the central axis, along the outer circumferential surface of the ball seat 4.

Moreover, the bottom surface portion 36 is a part to be a bottom surface of the inner chamber 25, and is formed in an inclined surface shape.

On the other hand, the connecting portion 22 is formed on the bottom portion 26 of the socket body 21 coaxially with this socket body 21, and is provided with a male screw portion 41 to be screwed into, for example, an unillustrated rack gear bar on the outer circumferential surface thereof.

Moreover, the ball seat 4 is formed of, for example, a synthetic resin such as polyacetal having flexibility, as shown in FIG. 5 through FIG. 7, in an approximately cylindrical shape whose one axial end side is reduced in diameter, is provided internally with a sliding surface 44 that holds the ball portion 15 so as to be rotatable by a caulking deformation, is formed with a bottom opening 45 communicated with the sliding surface 44 at one axial end side thereof, and is formed with an opening 46 communicated with the sliding surface 44 at the other axial end side thereof. In addition, for the outer circumferential portion of this ball seat 4, shown in FIG. 1, FIG. 4, and FIG. 5, from the opening 46 side to the bottom opening 45 side, an opening-side outer circumferential surface portion 51 held at the time of caulking deformation of the socket 3 by the opening-portion-side inner circumferential surface portion 31 of this socket 3, a fitting receiving portion 52 fitted with the fitting portion 32, an inclined outer circumferential surface portion 53 held by the inclined surface portion 33 of the socket 3, and a bottom-opening-side outer circumferential surface portion 55 held by the bottom surface portion 36 are continuously and concentrically formed in order.

For the sliding surface 44, from the opening 46 side to the bottom opening 45 side, an opening-side sliding surface 57 and a bottom-opening-side sliding surface 58 are continuously and concentrically formed in order.

The opening-side sliding surface 57 is a part that is formed in a cylindrical inner surface shape having an inside diameter dimension almost equal to the outside diameter dimension of the ball portion 15 of the ball stud 2, is deformed by a caulking deformation of the socket 3 to be a spherical shape, and holds the outer circumferential surface closer to the ball stud portion 16 side than the equator E of the ball portion 15.

In addition, the bottom-opening-side sliding surface 58 is formed in a spherical concave shape along the outer circumferential shape of the ball portion 15 of the ball stud 2. Furthermore, on this bottom-opening-side sliding surface 58, in the present embodiment, at almost the center area in the axial direction of the ball seat 4, formed is an oil pool portion 61 to hold a lubricant such as, for example, grease between the same and the outer circumferential surface of the ball portion 15. Therefore, the bottom-opening-side sliding surface 58 is divided into a first sliding surface 62 and a second sliding surface 63 by this oil pool portion 61. However, the oil pool portion 61 is not always necessary.

Moreover, the bottom-opening-side sliding surface 58 is formed so as to have the maximum inside diameter dimension smaller than the inside diameter dimension of the opening-side sliding surface 57. Therefore, at the connecting portion between the respective sliding surfaces 57 and 58, a step portion 65 to hold a lubricant between the same and the outer circumferential surface of the ball 15 is formed.

On the other hand, the opening-side outer circumferential surface portion 51 is formed in a circumferential surface shape having an outside diameter dimension almost equal to the inside diameter dimension of the opening-portion-side inner circumferential surface portion 31, and is extended to the bottom opening 45 side of the equator E of the ball seat 4.

In addition, the fitting receiving portion 52 is provided at a position corresponding to the fitting portion 32 in a state where the ball seat 4 is attached to the inner chamber 25 of the socket 3, that is, from a position apart from the equator E of the ball portion 15 at a predetermined distance, in the present embodiment, for example, approximately 2 to 3 mm, to the bottom opening 45 side being the side opposite to the opening 46, to the end portion of the inclined outer circumferential surface portion 53 apart from the bottom opening 45. Furthermore, on the fitting receiving portion 52, formed are a plurality of, in the present embodiment, eight, contact surfaces 67 that come into contact with the respective holding surfaces 37 in a state where the ball seat 4 is attached to the inner chamber 25 of the socket 3.

The contact surfaces 67 are formed in plane shapes almost parallel to the axial direction of the ball seat 4, are apart at almost equal intervals in the circumferential direction of the ball seat 4, and are respectively located on the central axis side of the ball seat 4 of the opening-side outer circumferential surface portion 51. Therefore, the fitting receiving portion 52 is formed in an almost regular polygonal shape, in the present embodiment, a regular octagonal shape, when viewed from the axial direction of the ball seat 4. Moreover, at the end portion on the opening 46 side of the contact surface 67, formed is an inclined contact portion 68 inclined so as to be smoothly continuous to the opening-side outer circumferential surface portion 51. This inclined contact portion 68 is a part held in contact with the inclined portion 37a of the holding surface 37.

Furthermore, the inclined outer circumferential surface portion 53 is formed in a circumferential surface shape inclined, from the opening-side outer circumferential surface portion 51 to the bottom-opening-side outer circumferential surface portion 55 side, toward the central axis of the ball seat 4.

Moreover, in the inclined outer circumferential surface portion 53, provided in a protruding manner are a plurality of, in the present embodiment, eight, projections 71 at the end portion on the fitting receiving portion 52 side and a plurality of, in the present embodiment, eight, projections 72 at the end portion on the bottom-opening-side outer circumferential surface portion 55 side, respectively. These projections 71 and 72 absorb a dimensional tolerance between the outer circumferential surface of the ball seat 4 and inner chamber 25 of the socket 3 as a result of being press contacted with the inclined surface portion 33 and being deformed and crushed when the ball seat 4 is housed in the inner chamber 25 of the socket 3 and the caulking portion 29 of the socket 3 is deformed by caulking, and support a load from the ball stud 2 by the inclined surface portion 33.

The projections 71 are each located in the vicinity of the central part of the contact surface 67 in the circumferential direction of the ball seat 4.

On the other hand, the projections 72 are each located between the contact surface 67 and contact surface 67 in the circumferential direction of the ball seat 4. Accordingly, these projections 71 and 72 are provided at alternately shifted positions in the circumferential direction of the ball seat 4.

For these projections 71 and 72, the providing positions and number can be arbitrarily set, and the projections 71 and 72 may not always be necessary.

In addition, the bottom-opening-side outer circumferential surface portion 55 is a part to be an outer bottom surface of the ball seat 4, is formed in an annular plane shape along the radial direction of the ball seat 4, and is located at an outer marginal portion of the bottom surface portion 36 of the socket 3.

Furthermore, the bottom opening 45 is opposed to the bottom surface portion 36 of the socket 3 to hold a lubricant between the bottom surface portion 36 and outer circumferential surface of the ball portion 15 of the ball stud 2.

Moreover, the opening 46 is a part which is communicated with the opening portion 27 and through which the stud portion 16 of the ball stud 2 is inserted.

Next, assembling procedures for the above embodiment will be described.

First, the ball seat 4 is housed in the inner chamber 25 of the socket 3.

At this time, when the ball seat 4 is inserted from the opening portion 27 side, the ball seat 4 and socket 3 are aligned so that the contact surfaces 67 and inclined contact portions 68 of the ball seat 4 make contact with the holding surfaces 37 and inclined portions 37a of the socket 3, the bottom-opening-side outer circumferential surface portion 55, inclined outer circumferential surface portion 53, fitting receiving portion 52, and opening-side outer circumferential surface portion 51 of the ball seat 4 are respectively held on the bottom surface portion 36, inclined surface portion 33, fitting portion 32, and opening-portion-side inner circumferential surface portion 31 of the socket 3, so that the ball seat 4 is held in the inner chamber 25.

Thereafter, in order to hold the ball portion 15 of the ball stud 2 on the sliding surface 44 of the ball seat 4, the socket 3, ball seat 4, and ball stud 2 are placed in a predetermined die of a caulking machine, and an external force is applied to the socket 3 so as to plastically deform the outer marginal portion of the opening portion 27 of the socket 3, whereby the opening-side outer circumferential surface portion 51 of the ball seat 4 is deformed along the outer circumferential surface of the ball portion 15 of the ball stud 2 by the caulking portion 29, and the projections 71 and 72 of the ball seat 4 are press contacted with the inclined surface portion 33 of the socket 3, so that the ball stud 2 is prevented from coming off from the socket 3 and ball seat 4.

As described above, according to the above embodiment, in the inner chamber 25 of the socket 3 in which the ball seat 4 has been stored, at a position apart from the position corresponding to the position of the equator E of the ball portion 15 to the bottom portion 26 side in the axial direction and on the equator E side of the bottom portion 26, the fitting portion 32 provided with a plurality of holding surfaces 37 is provided, and the fitting receiving portion 52 having a plurality of contact surfaces 67 which are in contact with the holding surfaces 37 in a state housed in the inner chamber 25 and fitted with the fitting portion 32 is provided on the outer circumferential surface of the ball seat 4, the ball seat 4 is forcibly prevented from rotating in the circumferential direction in the inner chamber 25 by the contact of the holding surfaces 37 with the contact surfaces 67 while suppressing effects such as a rotating torque on characteristics of the ball joint and easily securing the ball joint characteristics, whereby the ball seat 4 can be prevented from being rotated following a slide, that is, a rotation or a swing, of the ball portion 15.

In addition, by providing, on the opening portion 27 side of the holding surfaces 37 of the socket 3, the inclined portions 37a included so as to increase inner circumferential surface portion 31 in diameter, the inclined portions 37a serve as a guide when inserting the ball seat 4 into the inner chamber 25 and the insertion is thereby eased, and by making the inclined contact portions 68 of the ball seat 4 contact against these inclined portions 37a, the ball seat 4 can be more reliably prevented from being rotated in a following manner in the circumferential direction.

Furthermore, by forming the fitting portion 32 and fitting receiving portion 52 in almost regular polygonal shapes, when viewed from the axial direction, by the holding surfaces 37 and contact surfaces 67, respectively, it becomes easier, when fitting the ball seat 4 to the inner chamber 25 of the socket 3, to match each other's circumferential phases, so that the ball seat 4 and socket 3 can be easily aligned.

In particular, by forming the fitting portion 32 and fitting receiving portion 52 in almost regular octagonal shapes when viewed from the axial direction, respectively, the fitting portion 32 and fitting receiving portion 52 are approximated to circular shapes, so that the ball joint characteristics can be stabilized, and in comparison with, for example, when these are formed in polygonal shapes greater in the number of angles than the octagonal shapes, the effect to prevent the ball seat 4 from being rotated can be improved, and in comparison with when these are formed in polygonal shapes smaller in the number of angles than the octagonal shapes, phase matching becomes easier when fitting the ball seat 4 to the inner chamber 25 of the socket 3, and the ball joint characteristics can be stabilized.

Moreover, by forming the fitting portion 32 in an almost regular polygonal shape, the fitting portion can be easily formed in comparison with, for example, when being formed in a polygonal shape having a cute angles, and strength of the socket 3 can be secured.

Similarly, by forming the fitting receiving portion 52 in an almost regular polygonal shape, the fitting receiving portion can be easily formed in comparison with, for example, when being formed in a polygonal shape having acute angles, and strength of the ball seat 4 can be secured.

In addition, by providing, in the inclined outer circumferential surface portion 53 being an outer circumferential surface on the bottom opening 45 side of the fitting receiving portion 52 in the axial direction of the ball seat 4, the projections 71 and 72 that are press contacted with the inner chamber 25 in a state being fitted to the socket 3, the projections 71 and 72 absorb a dimensional tolerance by being deformed and crushed, whereby the ball seat 4 can be more reliably prevented from being rotated in a following manner, and a load from the ball stud 2 can be supported by the inclined surface portion 33 of the socket 3, so that rigidity and durability can further be improved.

Furthermore, by providing the projections 71 and 72 in the circumferential direction of the ball seat 4 in plural numbers, respectively, the ball seat 4 can be more reliably held in the inner chamber 25, and by providing the respective projections 71 on the fitting receiving portion 52 side of the inclined outer circumferential surface portion 53 and providing the respective projections 72 on the bottom-opening-side outer circumferential surface portion 55 side of the inclined outer circumferential surface portion 53, the ball seat 4 can be more reliably held in the inner chamber 25.

Moreover, by providing the projections 71 and 72 at alternately shifted positions in the circumferential direction of the ball seat 4, a load by the ball stud 2 can be supported by the entire inclined surface portion 33 of the socket 3.

In the above embodiment, it is also possible to form the fitting portion 32 and fitting receiving portion 52 in regular polygonal shapes.

### INDUSTRIAL APPLICABILITY

The present invention can be applied to, for example, an automobile suspension device, steering device, or the like.

1. A ball joint comprising:
a ball stud provided with a ball portion;
a substantially cylindrical bearing seat provided with a spherical sliding surface for holding the ball portion of said ball stud so as to be rotatable and an opening; and
a socket having a substantially cylindrical shape with a bottom provided with an inner chamber in which said bearing seat holding the ball portion of said ball stud is housed, an opening portion communicated with said opening, and a bottom portion, wherein
said socket is, at a position between a position corresponding to an equator position of said ball portion held by said bearing seat and said bottom portion, provided with a fitting portion that has a plurality of holding surfaces, and prevents said bearing seat from rotating with respect to said socket,
said bearing seat is provided with a fitting receiving portion having a plurality of contact surfaces that come into contact with said holding surfaces when said fitting portion is fitted to said plurality of fitting surfaces in the inner chamber, and
said fitting portion and said fitting receiving portion are formed in substantially polygonal shapes, when viewed from the axial direction, by said holding surfaces and said contact surfaces, respectively.

2. (canceled)

3. The ball joint as set forth in claim 1, wherein
the fitting portion and fitting receiving portion are formed in substantially regular octagonal shapes, when viewed from an axial direction of the ball joint, by the holding surfaces and contact surfaces, respectively.

4. The ball joint as set forth in claim 1, wherein
the bearing seat is provided, at an outside surface on a side adjacent to the opening of the fitting receiving portion in the axial direction, with projections that are configured to be press contacted with the inner chamber when the ball portion is fixedly fitted to the socket.

5. The ball joint as set forth in claim 3, wherein
the bearing seat is provided, at an outside surface on a side adjacent to the opening of the fitting receiving portion in the axial direction, with projections that are configured to be press contacted with the inner chamber when the ball portion is fixedly fitted to the socket.
